(19) United States
(12) Patent Application Publication
(10) Pub. No.: US 2009/0181217 A1
(43) Pub. Date: Jul. 16, 2009

(54) INK JET PRINTING ON SPORT COURT AND OTHER POLYMER TILES

(75) Inventors: Christopher S. Hobbensiefken, Gilbert, AZ (US); Joani Cortright, Phoenix, AZ (US); Neil Baker, Draper, UT (US)

Correspondence Address: Workman Nydegger;1000 Eagle Gate Tower, 60 East South Temple, Salt Lake City, UT, 84111, US

(73) Assignee: SWC Graphics, Inc., Phoenix, AZ (US)

(21) Appl. No.: 12/013,280

(22) Filed: Jan. 11, 2008

(51) Int. Cl. C08J 7/18; B32B 27/08

(52) U.S. Cl. 428/195.1; 427/511

(57) ABSTRACT

A method designed for printing a durable, abrasion-resistant image on a non-porous, non-planar polymer surface. The method includes providing a substantially non-planar, polymer substrate having a non-porous surface onto which an image is to be printed with an inkjet printer, activating the polymer surface so as to promote cohesive and chemical bonding interactions between the polymer surface and at least one inkjet ink, applying a layer of an opaque, white, UV-polymerizable primer ink to the polymer surface with the inkjet printer, overlaying an inkjet image on top of the layer of opaque, white primer ink with the inkjet printer, wherein the image comprises a mosaic of dots of a plurality of UV-polymerizable inkjet inks applied by the inkjet printer, and finally, the inkjet inks are cured or “dried” by polymerizing with a UV light source. Activating increases the surface tension of the polymer surface such that the inks are able to bond to the surface.

### CROSS-REFERENCE TO RELATED APPLICATIONS

Not applicable.

### BACKGROUND OF THE INVENTION

1. The Field of the Invention

The present invention is directed to the field of inkjet printing on non-porous surfaces. More particularly, the present invention is directed to a method for printing a durable, abrasion-resistant image on a sport court tile or other non-porous, polymer-based surfaces using an inkjet printer and technologies that increase the bonding energy between the polymer surface and the ink.

2. The Relevant Technology

Ink jet printers are well known in the printing industry along with laser electrophotographic printers, LED electrophotographic printers, dot matrix impact printers, thermal paper printers, film recorders, thermal wax printers, and dye diffusion thermal transfer printers. Ink jet printing has become recognized as a prominent contender in the digitally controlled, electronic printing arena because of, for example, its non-impact, low-noise characteristics, and its avoidance of toner transfers and fixing. However, not all media are readily printable with inkjet printing. In particular, there are difficulties associated with printing on non-porous, polymer based media. Nonetheless, there is an ongoing demand for improved digitally controlled inkjet printing systems that are able to produce abrasion-resistant, high color images at high speed and low cost using non-porous, polymer-based printing substrates, such as a plastics.

An inkjet printer is any printer that places extremely small droplets of ink onto paper or other printing media to create an image. An image is actually made up of a series of small dots produced when the droplets of ink strike the media. The dots, which are usually between about 50-60 microns in diameter, are positioned very precisely, with resolutions of up to 1440×720 dots per inch (dpi).

Inkjet printers are available in single color (usually black ink) and full-color versions. A full-color inkjet printer typically contains at least four ink colors. The most common ink colors are cyan, yellow, magenta, and black (“CMYK”), but commercial systems may use inks in addition to CMYK. Full-color images are created by positioning dots of the different colored inks close together in the right combination on the printing media to create the illusion of an array of colors.

At the heart of an inkjet printer is the print head. An inkjet printer's print head contains a series of nozzles that spray droplets of ink onto the printing media. The color, location, and frequency of droplet placement is controlled by the electronic hardware and programming of the printer. There are three basic printing methods used by inkjet printers: thermal bubble, piezo electric, and continuous inkjet.

In a thermal bubble print head, tiny resistors create heat, and this heat vaporizes ink to create a bubble. As the bubble expands, ink is pushed out of a nozzle onto the media. When the bubble pops or collapses, a vacuum is created that pulls more ink into the print head from the cartridge. A typical bubble jet print head has 300 or 600 tiny nozzles, and all of them can fire a droplet simultaneously.

In a piezo electric print head, piezo crystals are used in place of resistors. The crystal is located at the back of the ink reservoir opposite each nozzle. The piezo crystal receives a tiny electric charge that causes it to vibrate either toward or away from the ink nozzle. When the crystal vibrates toward the nozzle, it forces a droplet of ink out of the nozzle. When the crystal vibrates away from the nozzle, it pulls ink into the reservoir to replace the ink that was sprayed out.

In a continuous inkjet printer, a high-pressure pump directs liquid ink from a reservoir through a gunbody and a microscopic nozzle, creating a continuous stream of ink droplets. A piezoelectric crystal creates an acoustic wave as it vibrates within the gunbody and causes the stream of liquid to break into droplets at regular intervals—64,000 to 165,000 drops per second may be achieved. The ink droplets are subjected to an electrostatic field created by a charging electrode as they form. The charged droplets are directed by electrostatic deflection plates to print on the receptor material. Because the inkjet is in continuous use, nozzle clogging is not a problem. This allows the use of volatile solvents, such as ketones and alcohols, giving the ink the ability “bite” into the substrate and dry quickly.

The most common type of inkjet printers are desktop printers designed to print on letter-sized media. Desktop inkjet printers typically use aqueous inks that can be used to print on a variety of porous media, such as paper.

There are also commercial systems that are capable of printing on large-format media of various types. For example, the MacDermid ColorSpan company manufactures a line of commercial inkjet printers that are capable of handling a wide variety of flexible and rigid media. For example, the ColorSpan 9840UV printer has 16 print heads, the printer uses UV curable inks that are cured immediately after they are laid down by an onboard UV light source, and the printer can handle media up to about 250 cm in width by about 400 cm in length by about 70 mm in thickness. In theory such a printer could be used to print on any substrate.

In spite of inkjet printers being able to print on a wide variety of media, inkjet printers are limited in their ability to print on non-porous, polymer-based substrates, such as plastics. In general, inks applied by the methods discussed above are not able to bond to or absorb into a polymer surface. As a result, the ink sits on the surface of the plastic where it is likely to flake off at the slightest abrasion. Because of this, it has often been difficult or impossible to print a durable, abrasion resistant image on many polymer surfaces.

### BRIEF SUMMARY OF THE INVENTION

The present invention encompasses novel methods for printing a durable, abrasion-resistant image on a non-porous, optionally non-planar, polymer surface with an inkjet printer. It has been found that an inkjet printer can be used to print a durable, abrasion-resistant image on a non-planar, non-porous polymer surface by increasing the surface tension of the polymer surface according to the methods described herein. The technologies described herein provide methods for increasing the surface tension of a polymer surface such that an inkjet printer can be used to print a durable, abrasion-resistant image on a polymer surface with an inkjet printer. Inkjet printing on a polymer surface according to the present invention provides abrasion-resistant, full color images at a high speed and low cost.

The inkjet inks of the present invention can be applied by any conventional inkjet printing means, although the results are far superior to any presently available method. The presently preferred method of application involves preparing the polymer surface such that the surface tension of the polymer surface, as measured in dynes per centimeter, is increased to the point where the inkjet inks can form a cohesive bond to the surface. The methods of the present invention are compatible with essentially any inkjet printer system but yield better results. It should be understood that almost any type of inkjet printer will work with the methods of the present invention provided that the printer applies inks that are not water soluble once they are dried or cured on the print media.

In one embodiment, the present invention includes a method for printing a durable, abrasion-resistant image on a substantially non-planar and non-porous polymer surface with an inkjet printer. The method is configured to allow a practitioner to print a durable, abrasion resistant image on essentially any non-porous polymer surface. However, the disclosed methods are particularly well-suited for use in applying a durable, abrasion resistant image onto plastic sport court tiles and textured, non-skid plastic tiles.

In one exemplary embodiment, the method includes: (1) providing a substantially non-planar, polymer substrate having a non-porous surface onto which an image is to be printed with an inkjet printer; (2) activating the polymer surface so as to promote cohesive and chemical bonding interactions between the polymer surface and at least one inkjet ink; (3) applying a layer of an opaque, white, UV-polymerizable primer ink to the polymer surface with the inkjet printer; (4) overlaying an inkjet image on top of the layer of opaque, white primer ink with the inkjet printer, wherein the image comprises a mosaic of dots of a plurality of UV-polymerizable inkjet inks applied by the inkjet printer; and (5) curing or drying the inkjet inks by polymerizing with a UV light source.

Printing a durable, abrasion resistant image on a non-porous, polymer substrate is generally not practical because inks do not form cohesive bonding interactions with the polymer surface. This is the case because a non-porous polymer surface has no cracks, fissures, or pits that an ink can absorb into, and the surface of a polymer is relatively inert in that there are no available sites for chemical bonding to the polymer matrix. It is an aim of the present invention to activate the non-porous, polymer surface to promote the formation of cohesive bonding interactions between the polymer surface and the inkjet inks. It naturally follows that the activating step includes methods whereby the polymer surface is made less inert such that the inks are able to form cohesive bonding interactions with the surface.

In one embodiment, the surface is made less inert such that the inks are able to form cohesive bonding interactions with the polymer substrate by increasing the surface tension of the substrate. Exemplary surface tension increasing treatment methods include treating the polymer surface with at least one solvent, treating the polymer surface with a plasma etcher, and/or abrading the polymer surface (e.g., by sanding or sandblasting). Solvent treatment, plasma etching, and/or abrading are thought to activate the surface by creating micro-cracking, micro-pitting, bond scission, and/or by forming free radicals that form sites where the inks can form physical and or chemical bonding interactions with the surface.

In one embodiment, the inks are UV curable. This means that the inks are cured or “dried” more-or-less immediately after they are applied by exposure to a powerful UV light source. It is believed that the UV curing process also catalyzes the formation of bonds between the polymer surface and the inks at the sites of severed polymer bonds and free radicals.

In one embodiment, it is particularly advantageous to first apply a white ink layer over the polymer surface, followed by applying the image inks over the white ink layer. This provides a more vibrant image that is true to its intended color scheme because the white ink masks the color of the underlying polymer surface.

In one embodiment, exemplary non-planar, non-porous polymer surfaces according to the present invention include plastic sport court tiles or textured, non-skid plastic tiles. An exemplary plastic sport court tile or textured, non-skid plastic tile consists of a series of raised and depressed horizontal, vertical, and angled surfaces. It is an aim of the present invention to apply ink to the horizontal vertical, and angled surfaces. In one embodiment, the inks are applied to the horizontal, vertical, and angled surfaces such that the inks bond to a continuous array of bonding sites along the surfaces. One will of course appreciate that increasing the available number of bonding surfaces increases the durability of the image.

These and other advantages and features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1A illustrates an example of a polymer sport court tile;

FIG. 1B illustrates a perspective view of a polymer sport court tile;

FIG. 1C illustrates a cross-sectional view of a sport court tile showing details of the cross members;

FIG. 2A illustrates an example of a textured plastic flooring tile;

FIG. 2B illustrates a perspective view of a textured plastic flooring tile;

FIG. 2C illustrates a cross-sectional view of a textured plastic flooring tile showing details of the textured elements;

FIG. 3A illustrates a schematic view of an inkjet print head printing on the top and side surfaces of a sport court tile; and

FIG. 3B illustrates a schematic view of an inkjet print head printing on a textured plastic flooring tile.

### DETAILED DESCRIPTION OF THE PREFERRED EMBODIMENTS

The present invention extends to methods for applying an image to a polymer surface using an inkjet printer. In particular, the present invention is directed to methods for printing a durable, abrasion resistant image on a non-porous, optionally non-planar, polymer surface. The present invention encompasses novel methods for printing a durable, abrasion-resistant image on a non-porous, optionally non-planar, polymer surface with an inkjet printer. Exemplary non-porous, optionally non-planar, polymer surfaces according to the present invention include plastic sport court tiles and textured, non-skid plastic tiles.

It has been found that an inkjet printer can be used to print a durable, abrasion resistant image on a non-porous, optionally non-planar polymer surface by increasing the surface tension of the polymer surface according to the methods described herein. The technologies described herein provide methods for increasing the surface tension of a polymer surface such that an inkjet printer can be used to print a durable, abrasion-resistant image on a polymer surface with an inkjet printer. Inkjet printing on a polymer surface according to the present invention provides abrasion-resistant, full-color images at a high speed and low cost.

As used herein, the term “inkjet printer” generally refers to any printer that prints by precisely shooting small droplets of ink onto a printing media to create an image.

Along these lines, one will appreciate that inkjet printing is a fast, economical way transferring a vast range of image types onto a surface. Therefore, at least one aspect of the present invention is the development of methods whereby the inkjet technique can be configured to allow a practitioner to print a durable, abrasion resistant image on a non-porous, polymer surface. In particular, the methods of the present invention can include providing a non-porous, polymer substrate, activating the surface so that the inks will adhere to the surface, and printing an image on the surface.

The inkjet inks of the present invention can be applied by any conventional inkjet printing means, although the results are far superior to any presently available method. The presently preferred method of application involves activating the polymer surface such that the surface tension of the polymer surface, as measured in dynes per centimeter, is increased to the point where the inkjet inks can form a cohesive bond to the surface. It should be understood that almost any type of inkjet printer will work with the methods of the present invention provided that the printer applies inks that are not water soluble once they are dried or cured on the print media.

In one embodiment, the present invention includes a method for printing a durable, abrasion-resistant image on a substantially non-planar and non-porous polymer surface with an inkjet printer. The method includes a step of providing a polymer substrate having a non-porous surface onto which an image is to be printed with an inkjet printer. The substrate is preferably a non-porous, substantially non-planar injection molded plastic object composed of a polymer selected from a group consisting of polypropylene, polyethylene, polystyrene, polyvinylchloride, polyvinylidenechloride, polyethylene terephthalate, acrylonitrile butadiene styrene, ethylene vinyl acetate, polycarbonate, bayblend, and combinations thereof.

The method further includes activating the surface of the substrate with an activating agent to promote the formation of cohesive and chemical bonding interactions between the surface and at least one inkjet ink; applying a layer of an opaque, white, UV-polymerizable primer ink to the activated polymer surface with the inkjet printer; and overlaying an inkjet image on top of the layer of opaque, white primer ink with the inkjet printer, wherein the image comprises a mosaic of dots of a plurality of UV-polymerizable inkjet inks. The inks are cured and fused to the polymer surface by polymerizing the inkjet inks with a powerful UV light source.

In one embodiment, the surface activating step includes increasing the surface tension of the non-porous, polymer surface as expressed in dynes per centimeter (“dyne/cm”). Surface tension (or surface energy or surface tension energy) is the deciding factor on how well an ink will adhere to the polymer surface. It has been found that, for a proper bond to exist between an ink and a substrate surface, the substrate's surface tension must exceed the ink's surface tension by at least about 5-10 dyne/cm. The higher the surface tension of the solid substrate in relation to the liquid, the better its “wettability.” Better wettability translates into a greater likelihood that the inks will form cohesive bonding interactions with the polymer substrate.

The surface tension of typical inkjet inks is in the range of about 30 dyne/cm to about 35 dyne/cm. Accordingly, the surface tension of the substrate surface is advantageously raised to at least 40 dynes per centimeter. Preferably, the surface tension of the substrate surface is raised to at least about 50 dynes per centimeter, more preferably at least about 60 dynes per centimeter, and most preferably at least about 70 dynes per centimeter.

In one embodiment, the polymer surface is activated, and the surface tension of the polymer is increased, by treating the surface with at least one solvent. The surface treating solvent is selected from a group consisting of acetic acid, acetone, acetonitrile, benzene, 1-butanol, 2-butanol, 2-butanone, t-butyl alcohol, carbon tetrachloride, chlorobenzene, chloroform, cyclohexane, 1,2-dichloroethane, diethyl ether, diethylene glycol, diethylene glycol dimethyl ether, 1,2-dimethoxy-ethane, dimethylether, dimethylformamide, dimethyl sulfoxide, dioxane, ethanol, ethyl acetate, ethylene glycol, heptane, hexamethylphosphoramide, hexamethylphosphoroustriamide, hexane, methanol, methyl t-butylether, methylene chloride, N-methyl-2-pyrrolidinone, nitromethane, pentane, petroleum ether (ligroine), 1-propanol, 2-propanol, pyridine, tetrahydrofuran, toluene, triethyl amine, water, o-xylene, m-xylene, p-xylene, and mixtures thereof. In a preferred embodiment, the solvent is comprised of toluene.

Without being tied down to a particular theory, it is believed that the solvent treatment acts to activate the polymer surface and increase the surface tension of the surface by creating micro-cracking and micro-pitting at or near the polymer surface. In some instances, solvent treatment may also be able to sever molecular bonds and/or form free radicals at or near the surface layer of the polymer. When the inks are applied to a solvent treated surface they are able to form a more cohesive bond to the polymer surface relative to an untreated surface because the inks absorb into the microcracks and micropits increasing the effective surface area that the ink can bond to. Microcracks and micropits also provide for enhanced mechanical interlock between substrate and ink. Additionally, if chemical bonds are severed and/or free radicals are formed, the inks can also form chemical bonding interactions via the severed polymer chains and/or free radicals at the polymer surface. When the inks bond to the polymer matrix through the severed polymer chains and/or through free radicals, the inks essentially become an integral part of the polymer surface.

In one embodiment, treating the surface with at least one solvent further comprises a step of preparing a solvent-proof mask with a cut-out region in the approximate shape of the image that will later be applied to the polymer surface. In one embodiment, the solvent-proof mask comprises a nylon sheet material. In further steps, surface treating further comprises applying the mask to the polymer surface, applying the at least one solvent to the unmasked region (i.e., the cut-out region), and applying the opaque, white primer ink and the image onto the solvent treated region within a time between about 5 minutes and about 24 hours after solvent treatment.

In another embodiment, the surface of the polymer is activated and the surface tension is increased by abrading the polymer surface, e.g., using sandpaper or sand blasting. Without being tied down to one theory, it is believed that abrading acts to activate the polymer surface and increase the surface tension of the surface by creating scratching, micro-cracking, and micro-pitting at or near the polymer surface. Abrading may also be able to sever molecular bonds and/or form free radicals at or near the surface layer of the polymer. When the inks are applied to the abraded surface they are able to form a more cohesive bond to the polymer surface relative to an untreated surface because the inks absorb into the scratches, microcracks, and micropits increasing the effective surface area that the ink can bond to and enhancing mechanical interlock. Additionally, if bonds are severed and/or free radicals are formed, the inks are able to form chemical bonding interactions via the severed polymer chains and/or free radicals at the polymer surface. When the inks bond to the polymer matrix through the severed polymer chains and/or through free radicals, the inks essentially become an integral part of the polymer surface.

In another embodiment, the surface of the polymer is activated and the surface tension is increased by plasma etching the polymer surface. A plasma is a state of gaseous matter created by passing an electric charge through a gas. In a plasma, the gaseous atoms and/or molecules break down into ions, free electrons, and free radicals. These ions, free electrons, and free radicals are intensely reactive. When a plastic substance is placed under the plasma stream, the ions, free electrons, and free radicals in the plasma impact on the treatment surface with energies two to three times that necessary to break the molecular bonds on the surface of most substrates.

Without being tied to one theory, it is believed that the plasma etching step activates the polymer surface and increases the surface tension of the surface by creating micro-cracking and micro-pitting, and by severing polymer bonds and/or forming free radicals at or near the surface layer of the polymer. Plasma etching resulting in an oxidized surface, which promotes adhesion of ink thereto. Oxidation of the solid surface increases the surface tension, allowing for better wetting by liquids and promoting adhesion. Though studies have shown that development of strong oxidants is not essential for adhesion to take place, the surface tension increase is related to the oxidation of the polymer surface resulting in reactive polar groups on the surface, primarily hydroxyl, carbonyl and amide groups.

When inks are applied to a plasma treated surface they are able to form a more cohesive bond to the polymer surface relative to an untreated surface because the inks absorb into the microcracks and micropits increasing the effective surface area that the ink can bond to, thereby promoting mechanical interlock. Additionally, the inks are able to form chemical bonding interactions via the severed polymer chains, any remaining free radicals, and reactive hydroxyl, carbonyl and amide groups at the polymer surface. When the inks bond to the polymer matrix through the severed polymer chains, free radicals, and hydroxyl, carbonyl and amide groups, the inks essentially become an integral part of the polymer surface.

In one embodiment, an opaque, white primer ink is applied to the substrate after surface activation and before application of an image. In one embodiment, the opaque, white primer ink serves as a background upon which the image is applied. The purpose of the opaque, white primer ink is to increase the color brilliancy of the image that is applied. And while white is the preferred color for the primer ink, the use of other colors is within the scope of the present invention.

After the application of the opaque, white primer ink, the image is applied to the substrate by overlaying the image onto the white primer. The inkjet printer and the computer that it is attached to (if any) translate an electronic image or text file into an image that is applied by the inkjet printer. The inkjet printer applies the image as an array of small droplets of ink that form a composite image.

In one embodiment, the inks are cured more-or-less immediately after they are applied by exposure to a powerful UV light source. UV-curable inks consist mainly of acrylic monomers with an initiator package. The advantage of UV-curable inks is that they “dry” as soon as they are cured, and they produce a robust colorful image. In one embodiment, the UV light source promotes the formation of chemical bonds between the ink and the polymer surface. That is, it is believed that the UV curing process promotes the formation of chemical bonds between the inks themselves and also between the ink(s) and the substrate at the site of severed substrate polymer bonds and free radicals.

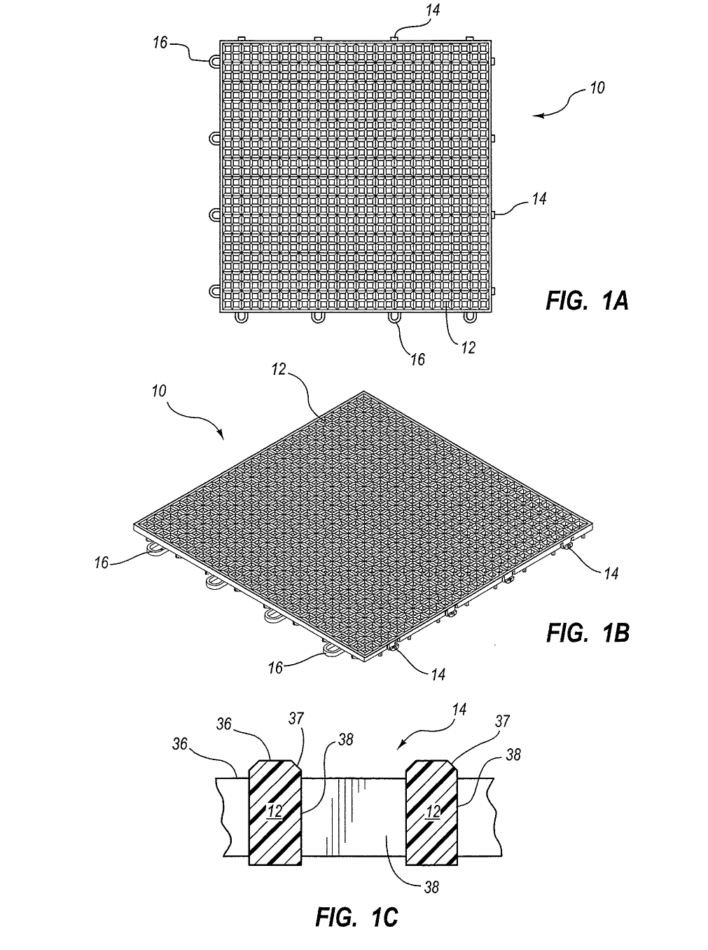

Turning now to FIG. 1, FIGS. 1A, 1B and 1C illustrate an example of a plastic sport court tile 10. FIG. 1A illustrates a top view of an exemplary polymer sport court tile 10. FIG. 1B illustrates a perspective view of a polymer sport court tile 10. FIG. 1C illustrates a cross-sectional view of a sport court tile 10 showing details of the cross members 12. Plastic sport court tile 10 is an exemplary substantially non-planar and non-porous polymer surface that is printed according to the present invention.

As shown in FIGS. 1A-1C, a plastic sport court tile 10 is a three-dimensional grid composed of cross members 12. The sport court tile 10 shown in FIGS. 1A-1C is composed of cross members 12 that meet at right angles, but other configurations are available. Most sport court tile products are injection molded of polypropylene plastic and measure about 12″ square, with thickness heights ranging from ½″ to ¾″. There are many companies that make sport court tiles including Flex Court, Rhino Court, Sport Court, Snap Sports, Versa-Court, Truesports, Gamecourts.com, and others.

As shown in FIG. 1, each cross member 12 is a rectangular shaped bar that is crossed at right angles by other rectangular shaped bars. Other angles are possible between crossing bar or reinforcing members. Each rectangular shaped bar and reinforcing member has a horizontal face 36 and at least one vertical face 38. In some configurations, as shown in FIG. 1C, cross members 12 may have an angled face 37 that forms a transition zone between horizontal face 36 and vertical face 38. In aggregate, the horizontal faces 36 of the cross members 12 form a playing surface consisting of solid and open portions. The open portions promote drainage. The vertical faces 28 of the cross members 12 are roughly equal in height to the thickness of the tile.

Square sport court tiles 10 can be connected together to form a playing surface of essentially any size by snapping individual tiles together in a grid fashion. The tiles 10 are connected together at the edges by a series of female connectors 14 and male connectors 16. That is, neighboring tiles are snapped together by lining up complementary male and female connector edges.

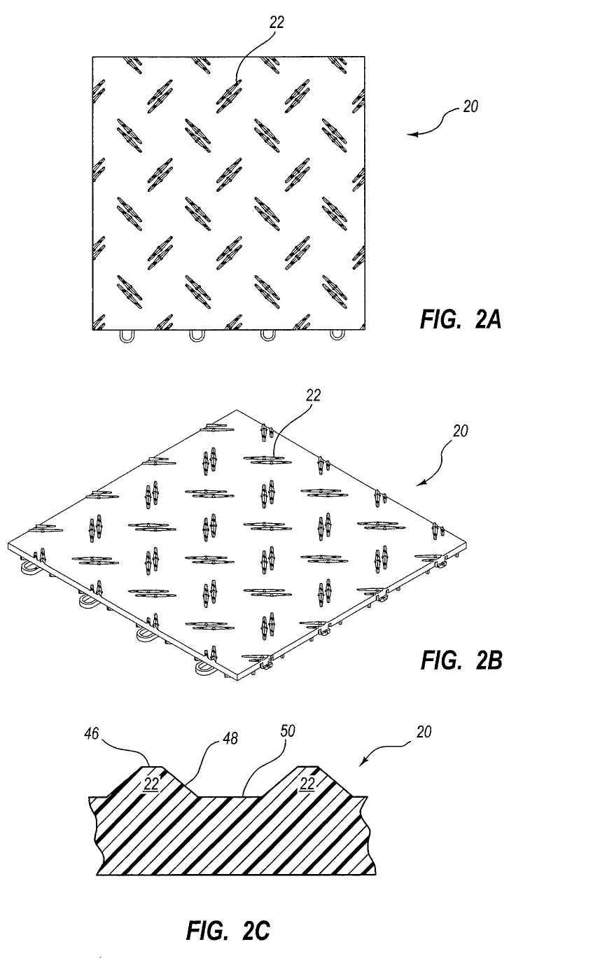

Turning now to FIG. 2, FIGS. 2A, 2B, and 2C illustrate a textured, non-skid plastic tile 20. FIG. 2A illustrates a top view of an exemplary textured, non-skid plastic tile 20. FIG. 2B illustrates a perspective view of textured, non-skid plastic tile 20. FIG. 2C illustrates a cross-sectional view of a textured, non-skid plastic flooring tile 20 showing details of the textured elements 22. Textured, non-skid plastic tile 20 is an exemplary substantially non-planar and non-porous polymer surface that is printed according to the present invention.

As shown in FIGS. 2A-2C, a textured, non-skip plastic tile 20 is composed of a plastic surface with textured protrusions or elements 22 arranged in a pattern on the surface. The tile 20 shown in FIGS. 2A-2C is a square tile with v-shaped protrusions 22 on the surface, but other configurations are available. For example, circular protrusions are also common. Most textured, non-skip tile products are injection molded of polypropylene plastic and measure about 12″ square, with thickness heights ranging from ⅛″ to ½″.

Focusing now on FIGS. 1C and 2C, one will appreciate that a sport court tile 10 and a textured, non-skid plastic tile 20 are examples of non-planar printing surfaces. That is, the surface of a sport court tile 10 or a textured, non-skid tile 20 is essentially composed of a series of horizontal, vertical, and angled surfaces (36 and 38 in FIG. 1C and 46 and 48 in FIG. 2C). In the case of a textured, non-skid plastic tile, textured elements 22 can be referred to as a series of protrusions (46 and 48) and depressions 50.

When taken together, these horizontal and vertical surfaces form a substantially non-planar printing surface to which an image can be applied. Inkjet printing is a practical method for printing on such a surface because the inks can be sprayed onto the various surfaces. Moreover, techniques that are appropriate for planar surfaces, such as application of adhesive back decals, are impractical for a non-planar surface like a sport court tile or a textured, non-skid tile.

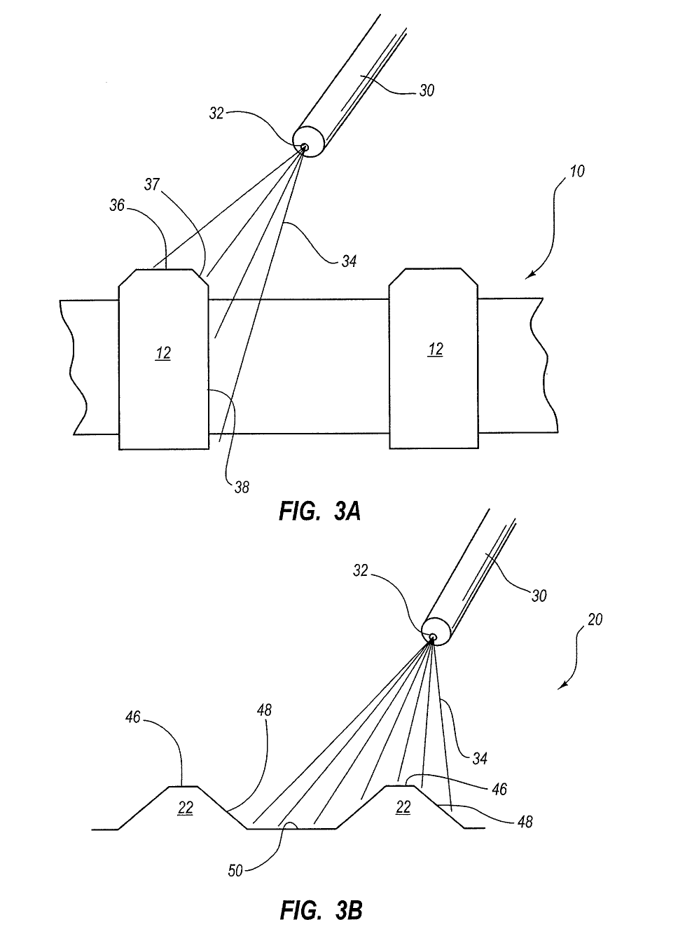

Turning now to FIG. 3, FIGS. 3A and 3B illustrate schematic views of an inkjet print head 30 with a single ink nozzle 32 spraying ink 34 onto the horizontal 36 and 46, vertical 38, angled 37 and 48, and depressed 50 surfaces of a sport court tile 10 or a textured, non-skid tile 20. In reality, a typical inkjet print head would include hundreds of ink nozzles simultaneously spraying ink onto the horizontal 36 and 46, vertical 38, angled 37 and 48, and depressed 50 surfaces of a sport court tile 10 or a textured, non-skid tile 20. In the depicted embodiment, the inkjet print head 30 of the inkjet printer is angled relative to the sport court tile 10 or textured, non-skid plastic tile 20 so as to apply ink to non-horizontal surfaces. As depicted in FIGS. 3A and 3B, the tilting of the print head 30 facilitates equal application of the inks 34 to the horizontal 36 and 46, vertical 38, angled 37 and 48, and depressed 50 surfaces of the sport court tile 10 or textured, non-skid plastic tile 20. In reality, there are hundreds of ink jet nozzles (e.g., 512 per head, with typically 7 different colors, including white, and 3 heads per color). The spray nozzles may be perpendicular to the polymer surface and/or they may be at an angle.

It is believed that because the inks are applied in a continuous layer to the horizontal 36 and 46, vertical 38, angled 37 and 48, and depressed 50 surfaces, they are able to form bonding interactions continuously along the horizontal 36 and 46, vertical 38, angled 37 and 48, and depressed 50 surfaces. By bonding continuously along multiple surfaces, the inks are able to better form chemical and physical bonding interactions with the plastic surface across a greater surface area adhere the sport court tile or the textured, non-skid tile.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method for printing a durable, abrasion-resistant image on a substantially non-planar and non-porous polymer surface with an inkjet printer, comprising:
providing a substantially non-planar, polymer substrate having a non-porous surface onto which an image is to be printed with an inkjet printer;
activating the surface of the polymer substrate so as to enhance bonding between the polymer and at least one inkjet ink;
applying a layer of an opaque, white, UV-polymerizable primer ink to the activated polymer substrate surface with the inkjet printer;
overlaying an inkjet image on top of the layer of opaque, white primer ink with the inkjet printer, wherein the inkjet image comprises a mosaic of dots of one or more UV-polymerizable inkjet inks applied by the inkjet printer; and
polymerizing the inkjet inks with a UV light source.

2. A method as recited in claim 1, wherein the substrate is a non-porous, substantially non-planar, injection molded plastic object comprising a polymer chosen from a group consisting of an injection molded polypropylene, polyethylene, polystyrene, polyvinylchloride, polyvinylidenechloride, polyethylene terephthalate, acrylonitrile butadiene styrene, ethylene vinyl acetate, polycarbonate, bayblend, and combinations thereof.

3. A method as recited in claim 1, the activating further comprising increasing a surface tension property of the non-porous, polymer surface so as to promote the formation of cohesive bonding interactions between the surface and at least one inkjet ink.

4. A method as recited in claim 3, wherein the surface tension of the surface is increased to at least about 40 dynes per centimeter.

5. A method as recited in claim 3, wherein the surface tension of the surface is increased to at least about 50 dynes per centimeter.

6. A method as recited in claim 3, wherein the surface tension of the surface is increased to at least about 60 dynes per centimeter.

7. A method as recited in claim 3, wherein the surface tension of the surface of the polymer surface is at least about 5 dynes per centimeter greater than the surface tension of the inkjet inks.

8. A method as recited in claim 3, increasing the surface tension further comprising treating the polymer surface with at least one solvent for activating the polymer surface by creating micro-cracking, micro-pitting, bond scission, and/or forming free radicals, and wherein the ink adheres to the surface by filling the micro-cracks and micro pits and/or by forming chemical bonds with the polymer surface via the severed bonds and/or free radicals.

9. A method as recited in claim 8, wherein the organic solvent is chosen from a group consisting of acetic acid, acetone, acetonitrile, benzene, 1-butanol, 2-butanol, 2-butanone, t-butyl alcohol, carbon tetrachloride, chlorobenzene, chloroform, cyclohexane, 1,2-dichloroethane, diethyl ether, diethylene glycol, diethylene glycol dimethyl ether, 1,2-dimethoxy-ethane, dimethylether, dimethylformamide, dimethyl sulfoxide, dioxane, ethanol, ethyl acetate, ethylene glycol, heptane, hexamethylphosphoramide, hexamethylphosphoroustriamide, hexane, methanol, methyl t-butylether, methylene chloride, N-methyl-2-pyrrolidinone, nitromethane, pentane, petroleum ether (ligroine), 1-propanol, 2-propanol, pyridine, tetrahydrofuran, toluene, triethyl amine, water, o-xylene, m-xylene, p-xylene, and combinations thereof

10. A method as recited in claim 8, the treating the polymer surface with at least one solvent further comprises:
preparing a solvent-proof mask, wherein the mask comprises a nylon sheet with a cut-out region in the approximate shape of the image to be applied;
applying the mask to the polymer surface;
applying the at least one solvent to the unmasked region; and
applying the opaque, white primer ink and the image onto the solvent treated region within a time between about 5 minutes and about 24 hours after solvent treatment.

11. A method as recited in claim 3, increasing the surface tension further comprising treating the polymer surface with a plasma etcher for activating the polymer surface by micro-cracking, micro-pitting, bond scission, and/or free radical formation, and wherein the ink adheres to the surface by filling the micro-cracks and micro pits and/or by forming chemical bonds with the polymer surface via the severed bonds and/or free radicals.

12. A method as recited in claim 3, increasing the surface tension further comprising abrading the polymer surface for activating the polymer surface by micro-cracking, micro-pitting, bond scission, and/or free radical formation, and wherein the ink adheres to the surface by filling the micro-cracks and micro pits and/or by forming chemical bonds with the polymer surface via the severed bonds and/or free radicals.

13. A method as recited in claim 1, wherein the layer of opaque, white, UV-polymerizable primer ink comprises a background configured to increase the color brilliancy of the image.

14. A method as recited in claim 1, wherein the UV light source promotes the formation of chemical bonds between the ink and the polymer surface.

15. A method as recited in claim 1, wherein the non-planar substrate is a plastic sport court tile comprising a plurality of horizontal and vertical surfaces.

16. A method as recited in claim 15, wherein at least one inkjet print head is angled relative to the sport court tile such that the inks are applied to both the horizontal and vertical surfaces.

17. A method as recited in claim 16, wherein the inks form bonding interactions continuously along both the horizontal and vertical surfaces.

18. A method as recited in claim 1, wherein the non-planar substrate is a textured, non-skid plastic flooring tile comprising a series of protrusions and depressions.

19. A method as recited in claim 17, wherein at least one inkjet print head is angled relative to textured, non-skid plastic flooring tile such that the inks are applied to the series of protrusions and depressions.

20. A method as recited in claim 17, wherein the inks form bonding interactions continuously along the series of protrusions and depressions.

21. A method for printing a durable, abrasion-resistant image on a substantially non-planar and non-porous polymer surface with an inkjet printer, comprising:
providing a substantially non-planar, polymer substrate having a non-porous surface onto which an image is to be printed with an inkjet printer;
activating the substantially non-planar, non-porous polymer surface by treating the surface with at least one solvent for activating the polymer surface by micro-cracking, micro-pitting, bond scission, and/or free radical formation, wherein the micro-cracking, micro-pitting, bond scission, and/or free radicals act to increase the surface tension of the polymer surface to at least 40 dynes per centimeter by promoting cohesive and chemical bonding interactions between the polymer surface and at least one inkjet ink;
applying a layer of an opaque, white, UV-polymerizable primer ink to the non-planar, non-porous polymer surface with the inkjet printer;
spraying an inkjet image onto the surface on top of the layer of opaque, white primer ink with the inkjet printer, wherein the image comprises a mosaic of dots of a plurality of UV-polymerizable inkjet inks applied by the inkjet printer; and
polymerizing the ink with a UV light source, wherein the UV light source promotes bond formation between the inks and the polymer surface.

22. A method as recited in claim 21, wherein the solvent is comprised of toluene.

23. A substantially non-planar polymer surface printed according the method of claim 20, wherein the ink bonds to a contiguous series of non-planar surfaces comprising a plurality of substantially horizontal and substantially vertical surfaces.

24. A method for printing a durable, abrasion-resistant image on a substantially non-planar and non-porous polymer surface with an inkjet printer, comprising:
providing a substantially non-planar, polymer substrate having a non-porous surface onto which an image is to be printed with an inkjet printer;
activating the substantially non-planar, non-porous polymer surface by plasma etching the surface so as to effect micro-cracking, micro-pitting, bond scission, and/or free radical formation, wherein the micro-cracking, micro-pitting, bond scission, and/or free radicals act to increase the surface tension of the polymer surface to at least 40 dynes per centimeter by promoting cohesive and chemical bonding interactions between the polymer surface and at least one inkjet ink;
applying a layer of an opaque, white, UV-polymerizable primer ink to the non-planar, non-porous polymer surface with the inkjet printer;
spraying an inkjet image onto the surface on top of the layer of opaque, white primer ink with the inkjet printer, wherein the image comprises a mosaic of dots of a plurality of UV-polymerizable inkjet inks applied by the inkjet printer; and
polymerizing the ink with a UV light source, wherein the UV light source promotes bond formation between the inks and the polymer surface.

25. A substantially non-planar polymer surface printed according the method of claim 24, wherein the ink bonds to a contiguous series of substantially non-planar surfaces comprising a plurality of horizontal and vertical faces.
